(19) United States
(12) Patent Application Publication
(10) Pub. No.: US 2019/0152867 A1
(43) Pub. Date: May 23, 2019

(54) METHOD FOR PRODUCING CERAMIC MATRIX COMPOSITE EXCELLENT IN ENVIRONMENT RESISTANCE

(71) Applicant: IHI Corporation, Koto-ku (JP)

(72) Inventors: Yousuke MIZOKAMI, Tokyo (JP); Takeshi NAKAMURA, Tokyo (JP); Shinji MUTO, Tokyo (JP); Hiroshige MURATA, Tokyo (JP)

(73) Assignee: IHI Corporation, Koto-ku (JP)

(21) Appl. No.: 16/251,245

(22) Filed: Jan. 18, 2019

Related U.S. Application Data
(63) Continuation of application No. PCT/JP2017/016661, filed on Apr. 27, 2017.

(30) Foreign Application Priority Data
Aug. 18, 2016 (JP) 2016-160571

(51) Int. Cl. C04B 35/80; C04B 41/87; C04B 41/00; C04B 41/45

(52) U.S. Cl. CPC C04B 35/806; C04B 41/87; C04B 41/0072; C04B 41/4543; C04B 2235/5256; C04B 2235/3463; C04B 2235/3826; C04B 2235/5244; C04B 41/4584

(57) ABSTRACT

A method for producing a ceramic matrix composite is provided with: weaving a fabric from fibers of SiC; infiltrating SiC into pores in the fabric by vapor phase infiltration; executing solid phase infiltration by immersing the fabric after the vapor phase infiltration in an immersion liquid including a solvent, a SiC powder and a glass powder to infiltrate SiC and glass into the fabric; and executing liquid phase infiltration by immersing the fabric after the solid phase infiltration in an immersion liquid including a solvent and an organic silicon polymer and calcine the immersed fabric to infiltrate SiC into the fabric.

### CROSS-REFERENCE TO RELATED APPLICATIONS

This application is a Continuation Application of PCT International Application No. PCT/JP2017/016661 (filed Apr. 27, 2017), which is in turn based upon and claims the benefit of priority from Japanese Patent Application No. 2016-160571 (filed Aug. 18, 2016), the entire contents of which are incorporated herein by reference.

### BACKGROUND

### Technical Field

The disclosure herein relates to a method for producing a ceramic matrix composite applied to a device necessitating high-temperature oxidation resistance in addition to strength, such as an aeronautic jet engine.

### Related Art

Ceramics have excellent heat resistance but at the same time many of them have a drawback of brittleness. In order to overcome the brittleness, many attempts to use a ceramic (matrix) as a matrix and combine fibers of any inorganic substance such as silicon carbide (SiC) therewith have been made. The fibers are frequently coated with a coating of carbon, boron nitride (BN) or such in order for better combination between the matrix and the fibers.

As a process for combining, proposed are methods of chemical vapor infiltration (CVI), liquid phase infiltration (such as polymer infiltration pyrolysis (PIP)), solid phase infiltration (SPI), and molten metal infiltration (MI) for example. According to the PIP method for example, polymer solution is infiltrated into a fabric of fibers of SiC or such and is calcined at a high temperature to generate ceramic, so that the generated ceramic functions as a matrix and forms a composite with the fibers. The polymer solution is properly selected in accordance with ceramics to be generated. Where polycarbosilane is selected for instance, a matrix of SiC is generated.

It is not easy to thoroughly fill pores or openings among fibers with the matrix by any method. Japanese Patent Application Laid-open No. 2008-081379 discloses a related art.

### SUMMARY

If air or water vapor at high temperature intrudes in a ceramic matrix composite and gets in contact with the coating of carbon or BN, oxidation and damage thereby will relatively rapidly progress. Then the combination between the fibers and the matrix will be deteriorated and the strength of the ceramic matrix composite will be severely reduced. How thoroughly cracks or pores acting as pathways for the air or the water vapor could be closed is a problem in order to prevent it.

According to an aspect, a method for producing a ceramic matrix composite is provided with: weaving a fabric from fibers of SiC; infiltrating SiC into pores in the fabric by vapor phase infiltration; executing solid phase infiltration by immersing the fabric after the vapor phase infiltration in an immersion liquid including a solvent, a SiC powder and a glass powder to infiltrate SiC and glass into the fabric; and executing liquid phase infiltration by immersing the fabric after the solid phase infiltration in an immersion liquid including a solvent and an organic silicon polymer and calcine the immersed fabric to infiltrate SiC into the fabric.

### BRIEF DESCRIPTION OF DRAWINGS

FIG. 1 shows production steps for a ceramic matrix composite according to an embodiment.

FIG. 2 is a flowchart showing steps of infiltration, solid phase infiltration, liquid phase infiltration, and filling among the production steps in more detail.

FIG. 3 is a drawing schematically showing a step of oscillating applicable to the step of solid phase infiltration for instance.

FIG. 4 is a drawing schematically showing the step of liquid phase infiltration.

FIG. 5 shows a microstructure of a ceramic matrix composite after the step of solid phase infiltration, in which the ratio of glass to SiC is 0%.

FIG. 6 shows a microstructure of a ceramic matrix composite after the step of solid phase infiltration, in which the ratio of glass to SiC is 10%.

FIG. 7 shows a microstructure of a ceramic matrix composite after the step of solid phase infiltration, in which the ratio of glass to SiC is 30%.

FIG. 8 shows a microstructure of a ceramic matrix composite after the step of solid phase infiltration, in which the ratio of glass to SiC is 80%.

FIG. 9 shows a microstructure of a ceramic matrix composite after the step of solid phase infiltration, in which the ratio of glass to SiC is 100%.

FIG. 10 shows S-N curves of ceramic matrix composites, which compare one including glass with another not including glass.

FIG. 11 shows S-N curves of ceramic matrix composites, which compare one being sprayed with another not being sprayed.

FIG. 12 is a graph showing influence of volume fractions of glass on thickness changes of test pieces by a water vapor exposure test.

FIG. 13A shows an outer appearance of a test piece not including glass after the water vapor exposure test.

FIG. 13B shows an outer appearance of a test piece including 60 vol % glass after the water vapor exposure test.

FIG. 13C shows an outer appearance of a test piece including 100 vol % glass after the water vapor exposure test.

FIG. 14 is a graph showing high-temperature fatigue test results of the ceramic matrix composites, in which the vertical axis means cycles until fracture.

### DESCRIPTION OF EMBODIMENTS

Exemplary embodiments will be described hereinafter with reference to the appended drawings.

Preferable uses of ceramic matrix composites according to the embodiments are machine components exposed to high-temperature oxidative atmospheres such as components constituting aeronautic jet engines, and its examples are turbine blades or vanes, combustors, after burners and such. Of course any other uses are possible.

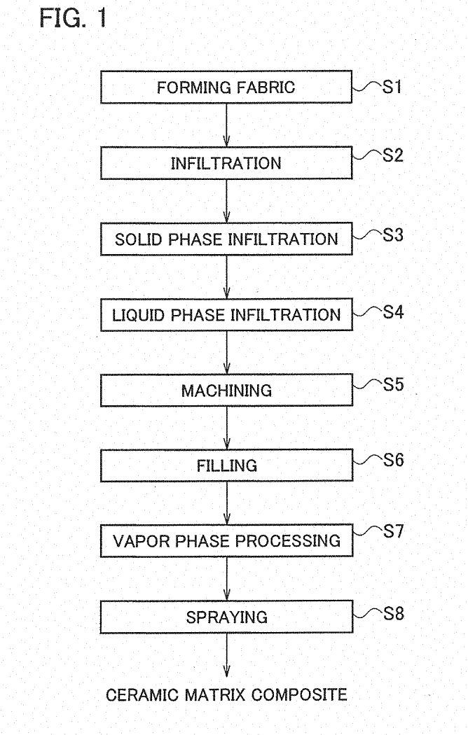

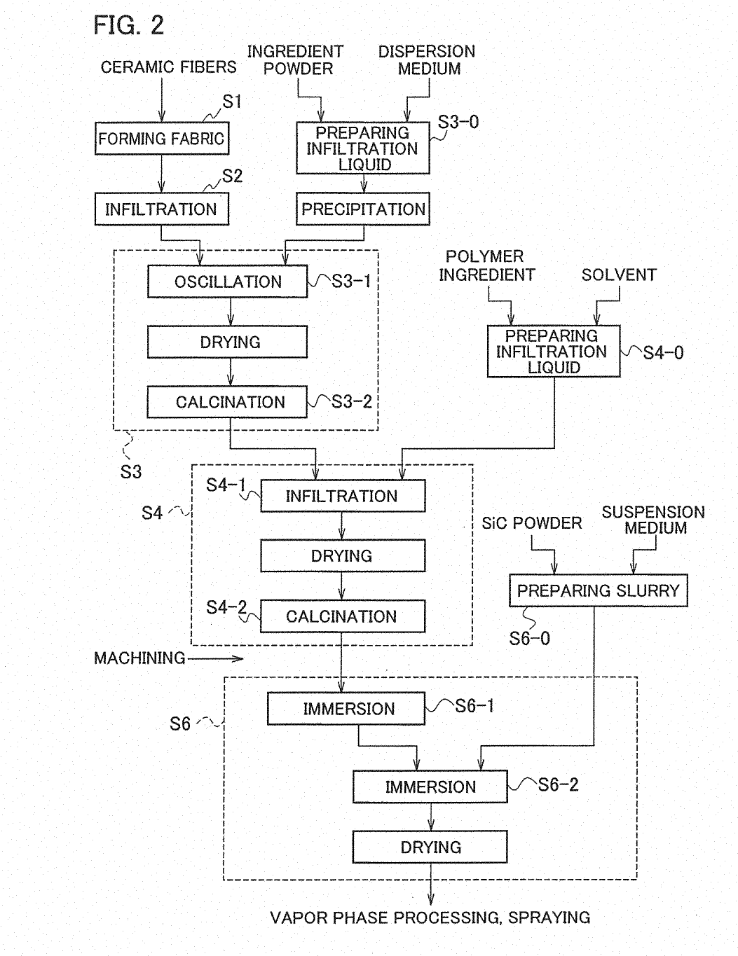

A ceramic matrix composite of an embodiment in general includes a fabric of fibers of silicon carbide (SiC) and a matrix including SiC and glass, which combines the fibers together. Referring mainly to FIGS. 1 and 2, the ceramic matrix composite is produced generally by weaving the fabric from the fibers of SiC (step S1), infiltrating the matrix including SiC and glass into the fabric by a plurality of methods in combination (steps S2-S4), machining it (step S5), filling pores opened on its surface (step S6), and coating the surface by one or more methods (steps S7, S8).

To the fabric applicable are ingredient fibers of SiC. Those commercially available, such as Tyranno Fiber ZMI grade (UBE Industries, Ltd.) for instance, can be used. Or, the ingredient fibers can include fibers of another inorganic substance in addition to, or in place of, SiC. The inorganic substance can be properly selected in accordance with required properties.

The ingredient fibers may be coated with any proper material. Carbon and boron nitride (BN) may be exemplified as the coating material but not limited thereto. BN is superior in oxidation resistance to carbon. To coat the fibers with the material, any publicly known methods such as a vapor phase method or a dipping method may be used. The coating on the ingredient fibers prevents propagation of crevices from the matrix to the fibers, and as well reinforces bonding with the matrix. In light of pursuit of perfect covering, the coating may be executed before weaving the fabric but may be alternatively executed thereafter.

From the ingredient fibers, or the ingredient fibers with the coating, the fabric 10 is woven and formed into a predetermined shape determined in accordance with its use (the weaving and forming step S1). As the solid matrix combines the fibers together after the subsequent infiltration steps and consequently the fabric 10 will be hardly deformable, a so-called “near-net” shape production is preferable in this formation step.

The fabric may be a two-dimensional fabric in which the fibers run substantially on a single plane but instead may be a three-dimensional fabric in which the fibers three-dimensionally run. The three-dimensional fabric is superior in improvement of three-dimensional isotropy of strength. In regard to the ratio of the volume that the fibers occupy to the apparent volume of the fabric including pores among the fibers (referred to as “fiber ratio” hereinafter), higher ratios are advantageous in light of strength but lower ratios facilitate infiltration of the matrix. Thus the fiber ratio is for instance from 30 to 50%.

In order to infiltrate SiC into the fabric 10, publicly known chemical vapor infiltration (CVI) is executed (the infiltration step S2). The infiltration step S2 is executed in a way as described hereafter. For CVI, a chamber capable of controlling the internal atmosphere, such as a publicly known hot-wall electric furnace, is applicable to the step. The furnace is so constituted as to gas-tightly close its interior, have flow paths connected thereto for introducing ingredient gas therein, and allow the interior depressurized. For the depressurization and the exhaust, the furnace is connected to a vacuum pump. The flow paths may have valves or mass controllers in order to control flow rates of gases, and the internal pressure is arbitrarily regulated by the balance between the gas flow rates and the rate of evacuation by the vacuum pump. The pressure during chemical reaction is in a range of from 1 through 100 torr for instance.

The furnace is in general provided with a reaction chamber and a heater along therewith. The reaction chamber is for instance, but not limited to, a quartz tube having openings at both ends. The heater is any proper heating means such as a carbon heater.

The SiC ingredient gases are stored in tanks in a liquid state for instance and are, with being gradually vaporized at room temperature or by properly heated, fed to the reaction chamber. The SiC ingredient gases are those creating solid SiC when thermally decomposed, and examples thereof are methyltrichlorosilane, dimethyldichlorosilane, and trimethylchlorosilane. Or, a mixture gas of silicon tetrachloride and methane may be applicable thereto. As well, hydrogen is served in a state of being filled in a gas cylinder. In addition thereto, for the purpose of dilution or any other purposes, one or more other gases such as nitrogen are available. Tanks or gas cylinders storing these ingredient gases are, via the flow paths, connected to the furnace and the flow rates thereof are independently regulated by means of the valves or the mass flow controllers.

The formed fabric 10 is introduced into the reaction chamber. After gas-tightly closing the furnace, by operating the vacuum pump, the interior of the reaction chamber along with the fabric 10 is placed under proper vacuum. Next, by powering the heater, the fabric 10 is heated up to a temperature from 900 through 1000 degrees C. for instance. With keeping the temperature, the aforementioned ingredient gases are introduced through the flow paths into the reaction chamber and the interior of the reaction chamber is regulated under from 1 through 100 torr for instance.

The SiC ingredient gases are thermally decomposed into solid SiC and deposited onto surfaces of the ingredient fibers, which partially fill the pores in the fabric 10 and constitute part of the matrix combining the ingredient fibers together.

In general, the matrix created in this step cannot fill the pores completely. In regard to the ratio of the volume (volume fraction) of the matrix created in this step to the apparent volume of the fabric 10 including the pores, higher volume fractions are more advantageous in improvement of the strength but, if overly high, it may cause negative impact on infiltration in the subsequent steps. Thus the volume fraction is from 25 to 35% for instance. The volume fraction is controlled by regulation of the temperature, the pressure and the reaction time. After finishing the reaction, preferably the fabric 10 is gradually cooled in the furnace and next extracted out of the furnace.

SiC including glass is further infiltrated into the fabric 10 after the infiltration step S2 (the solid phase infiltration step S3).

In parallel with the steps described heretofore, an infiltration liquid 20 is prepared, in which ingredient powders are dispersed in a dispersion medium (the infiltration liquid preparing step S3-0). The medium is an organic solvent for instance, and methanol, ethanol, xylene and such can be exemplified as the organic solvent. The infiltration liquid 20 may contain a polymer ingredient such as polycarbosilane. Xylene and polycarbosilane are for instance mixed in a ratio of 70 mass %:30 mass %. The infiltration liquid 20 may further contain any additives for regulating its viscosity. To add proper viscosity thereto is contributive to suppression of powder aggregation, thereby maintaining a proper dispersion state. In place thereof, or in addition thereto, any dispersing agent that promotes dispersion of powders may be added thereto. These additives, in the subsequent oscillation step, promote infiltration of the powders into the pores among the fibers.

The ingredient powders are a SiC powder and a glass powder. While any restriction is not put on the grain size of the ingredient powders, smaller grain sizes facilitate infiltration into minute pores among the fabric but larger grain sizes are advantageous in improvement of the infiltration ratio. As a typical example, both the grain sizes of these powders are 1 micrometer or more and 10 micrometers or less. While any commercially available SiC powders are applicable thereto, a SiC powder of 9.5 micrometer in average grain size for example is used. While various glasses are applied to the glass powder, borosilicate glass is preferably used. Borosilicate glass is advantageous in preventing the matrix from creating defects particularly at high temperatures or heat cycles. Its grain size is for instance 5.0 micrometers in average grain size.

The mixture ratio of SiC to glass in the ingredient powders may be arbitrarily selected from the range of 0 to 100 vol % but its details will be described later.

Further the powders may contain a compound of a powder of carbon and a powder of silicon for instance. The powder of carbon and the powder of silicon are mixed together in a molar ratio of 1:1 (about 3:7 in weight ratio). This compound would, by being calcined, create SiC to constitute a part of the matrix. To the powder of carbon applicable is any of a carbon powder produced by vapor phase reaction, a powder of synthetic graphite by calcination or such, a natural graphite powder, and such. Also in regard to the powder of silicon, any particular restriction is put on its nature and any commercially available powder is applicable thereto.

The ingredient powders are admixed with the dispersion medium. The mixture ratio of the ingredient powder to the dispersion medium is for instance 40 vol %:60 vol %. Any proper means is used to agitate the compound. Admixture may be executed before immersion of the fabric 10 as described later but the fabric 10 may be in advance immersed in the dispersion medium before admixture.

The immersion liquid 20 may be, after being prepared, left to stand still for a certain time to create a precipitation 30 (a precipitation step). While the density of the ingredient powders gets higher in the precipitation 30 than in the suspension, the ingredient powders can coexist with the dispersion medium. Therefore, in the subsequent oscillation step, the dispersion medium is not barred from functioning as a medium for conducting oscillation to the ingredient powders and this is rather advantageous in densely infiltrating the ingredient powders into the fabric 10.

The fabric 10 is immersed in the immersion liquid 20 including the ingredient powders. Alternatively, as described already, the fabric 10 may be immersed in the dispersion medium before admixing the ingredient powders therewith. In the latter case, the SiC powder and the glass powder are later put therein and agitated. To promote defoaming, this may be put under vacuum for 5 minutes or so.

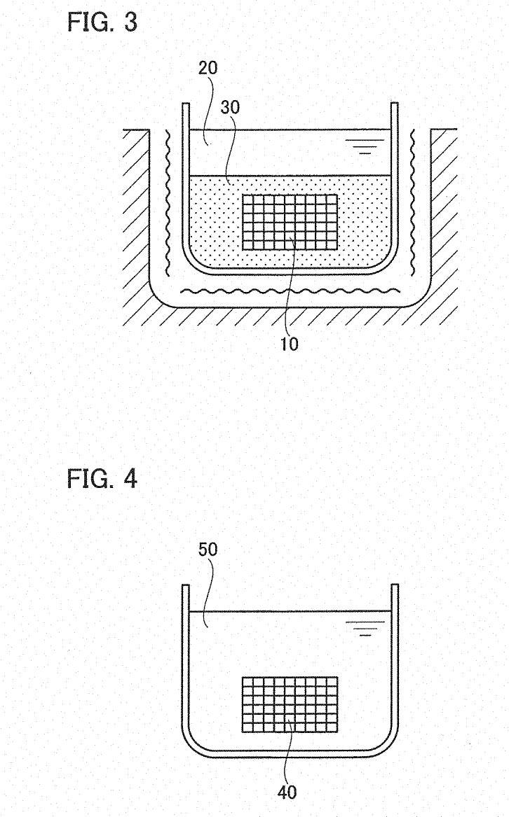

Referring to FIG. 3, the fabric 10 is buried in the immersion liquid 20, or in the precipitation 30 if present, and the totality is oscillated from the exterior (the oscillation step S3-1). While any particular restriction is not put on the oscillation condition, use of an ultrasonic oscillation device may be preferable. An ultrasonic oscillation device commercially available in the name of SONOQUICK (ULTRASONIC ENGINEERING Co., Ltd.) is an example thereof. By this device, ultrasonic wave with frequency of from 10 to 50 kHz and an output power of from 200 to 300 W is applied to the immersion liquid 20 for from 10 to 15 minutes. This oscillation step may be executed in the air at the room temperature and the atmospheric pressure but may be executed under reduced or increased pressures. Through the oscillation step, the ingredient powders including glass infiltrate into the fabric 10.

Referring again to FIGS. 1 and 2, the fabric 10 including the ingredient powders is taken out of the immersion liquid 20 and is dried by being exposed to the air at the room temperature or a properly elevated temperature. The duration for drying is for instance 30 minutes.

Next the fabric 10 with the ingredient powders is calcined (the calcination step S3-2). Calcination is executed by heat treatment in a furnace purged or sealed with an inert gas such as argon. The heat treatment is executed at from 900 through 1200 degrees C. for instance because glass would not be readily softened at relatively low temperatures but extremely high temperatures overly soften glass and could deteriorate its microstructures. By being calcined, the glass is softened and fills the open pores in the fabric 10, which constitutes a part of the matrix combining the ingredient fibers. The resultant article will be referred to as an intermediary body 40.

After the calcination step, preferably the intermediary body 40 is gradually cooled in the furnace and next extracted out of the furnace. As the intermediary body 40 yet includes pores therein, to fill the pores, liquid phase infiltration is executed (the liquid phase infiltration step S4).

In parallel with the solid phase infiltration step S3, an infiltration liquid 50 is prepared, in which polymer ingredient is suspended in a suspension medium (the infiltration liquid preparing step S4-0).

The polymer ingredient is a proper polymer that creates SiC and/or C when calcined, and the term “polymer ingredient” is so defined and used throughout the present description and the appended claims. The polymer that creates SiC is a proper organic silicon polymer with a molecular chain having carbon and silicon and its example is, although not exhaustive, polycarbosilane and polytitanocarbosilane. The following description relates to a case where polycarbosilane is applied to the polymer ingredient.

While any restriction is put on the suspension medium, xylene can be exemplified as the polymer ingredient readily dissolves therein. Polycarbosilane is admixed with xylene in a ratio of 30 mass %:70 mass % for instance, and the totality is properly agitated to form the infiltration liquid 50.

Referring to FIG. 4, the intermediary body 40 is immersed in the infiltration liquid 50 (the infiltration step S4-1). This infiltration step may be executed in the air at room temperature and atmospheric pressure but may be executed at reduced or increased pressures. Infiltration is executed for 5 minutes or more for instance and, through the infiltration step, the polymer ingredient infiltrates in the intermediary body 40.

Referring again to FIGS. 1 and 2, next the intermediary body 40 with the polymer ingredient is taken out of the infiltration liquid 50 and is dried by being exposed to the air at room temperature or a properly elevated temperature. Subsequently the intermediary body 40 with the polymer ingredient is calcined (the calcination step S4-2). This calcination is executed in a way similar to the calcination step S3-2. The heat treatment is executed at from 800 through 1200 degrees C. for instance because the polymer ingredient would not be readily decomposed at relatively low temperatures but extremely high temperatures may damage the fibers. The duration of the heat treatment is preferably 4 hours at the maximum temperature. By being calcined, the polymer ingredient is decomposed to form SiC, which further fills the pores in the intermediary body 40 and combines the fibers together, thereby firming the structure of the ceramic matrix composite.

After calcination, preferably being gradually cooled in the furnace, the ceramic matrix composite is taken out of the furnace. If necessary, any finishing process such as machining is carried out (the machining step S5).

After machining, as the infiltrated powders or such in part might leave the composite, open pores are often exposed on the surface of the ceramic matrix composite. To close the open pores, preferably, filling is executed (the filling step S6).

In parallel with the steps described heretofore, a slurry is prepared, in which a SiC powder is suspended in a suspension medium (the slurry preparation step S6-0). The dispersion medium is an organic solvent for instance, and methanol, ethanol, xylene and such can be exemplified as the organic solvent. The following description relates to an example where ethanol is applied to the solvent. SiC is admixed with ethanol in a ratio of 40 vol %:60 vol % for instance. Any proper means is used to agitate the compound.

The ceramic matrix composite is immersed in the slurry. Or, before immersing it in the slurry, the ceramic matrix composite may be immersed in ethanol and placed in a vacuum (the immersion step S6-1), and may be thereafter immersed in the slurry (the immersion step S6-2). After immersion, oscillation may be applied thereto or the totality may be left to stand still. Subsequently the ceramic matrix composite is taken out of the slurry and is dried in the air at 105 degrees C. for instance. Drying may require 20 minutes for instance.

Through the filling step, the opened pores on the surface are filled with SiC. The filled ceramic matrix composite is placed into a surface coating step S7 for the purpose of coating the surface with SiC.

The surface coating step S7 may be executed by a chemical vapor deposition step like as CVI for instance. More specifically, into a furnace such as a hot-wall electric furnace capable of controlling the internal atmosphere, the filled ceramic matrix composite is introduced, and, after gas-tightly closing the furnace, by operating a vacuum pump, the totality thereof is placed under proper vacuum. Next, by powering the heater, the filled ceramic matrix composite is heated up to a temperature from 900 through 1000 degrees C. for instance, and, with keeping the temperature, ingredient gases including an SiC ingredient gas are introduced into the reaction chamber. The interior of the reaction chamber is regulated under from 1 through 100 torr for instance.

The SiC ingredient gas is thermally decomposed into solid SiC to cover the surface of the filled ceramic matrix composite. After finishing the reaction, preferably the coated ceramic matrix composite is gradually cooled and then taken out of the furnace.

The surface of the coated ceramic matrix composite is, preferably, further coated with an oxidation-resistant coating such as any rare-earth silicate. A spraying step S8 for instance is applicable to this coating. The spraying step may be executed by atmospheric spraying or, to suppress oxidation of the coating and inclusion of gases in the coating, by reduced-pressure spraying.

To increase bonding force between the ceramic matrix composite and the sprayed layer, a bonding layer may be formed in advance. The bonding layer is formed of Si for instance and its thickness is from 10 to 100 micrometers for instance. The bonding layer may be formed also by spraying, and atmospheric spraying is applicable thereto but instead reduced-pressure spraying is applied thereto in order to prevent oxidation of Si.

After forming the bonding layer, subsequently mullite powder and ytterbium silicate powder are introduced into the spray torch to form a coating of mullite and ytterbium silicate on the bonding layer. Also to this step applicable is spraying. This spraying may be executed either atmospheric spraying or reduced-pressure spraying. During the spraying step, on the surface of the ceramic matrix coating, calcination of mullite and ytterbium silicate develops to create the oxidation-resistant coating.

The amount and the grain size of the glass powder to be infiltrated critically affect the effect of shielding the object from air and water vapor. More specifically, in the calcination steps S3-2 and S4-2, the glass along with a small amount of air involved in the pores expands and therefore tends to escape therefrom. Additionally, as thermal expansion coefficients of glasses considerably differ from that of SiC, the difference tends to create cracks around interfaces between SiC and glass. To prevent these defects, it is necessary to provide paths through which air can escape during calcination. On the other hand, if these paths are overly broad, repetition of SiC infiltration will not successfully close the paths and then the effect of filling the pores will be insufficient.

In light of improvement of the effect of filling the pores, the ratio of glass to SiC is preferably made higher. Thus it is 10 vol % or more for instance, or more preferably 30 vol % or more. In light of prevention of crack generation in the matrix, however, lower ratios are preferable, and therefore the ratio of glass to SiC is 80 vol % or less for instance, or more preferably 60 vol % or less. The average grain size is 1 micrometer or more and 10 micrometers or less, or more preferably 4 micrometers or more and 10 micrometers or less.

To verify the effects, some tests have been carried out on the following examples and comparative examples.

SiC fibers of 11 micrometers in diameter, available in the trade name of “Tyranno Fiber ZMI grade” (UBE Industries, Ltd.), were three-dimensionally woven into a fabric and then cut into rectangular planer test pieces. The required number of test pieces was prepared and each dry weight was determined.

Some variations were made in the ratio of SiC to glass in the solid phase infiltration step to form ceramic matrix composites respectively. Visual observation was made on the resultant articles and whether they had any issues in appearance were determined.

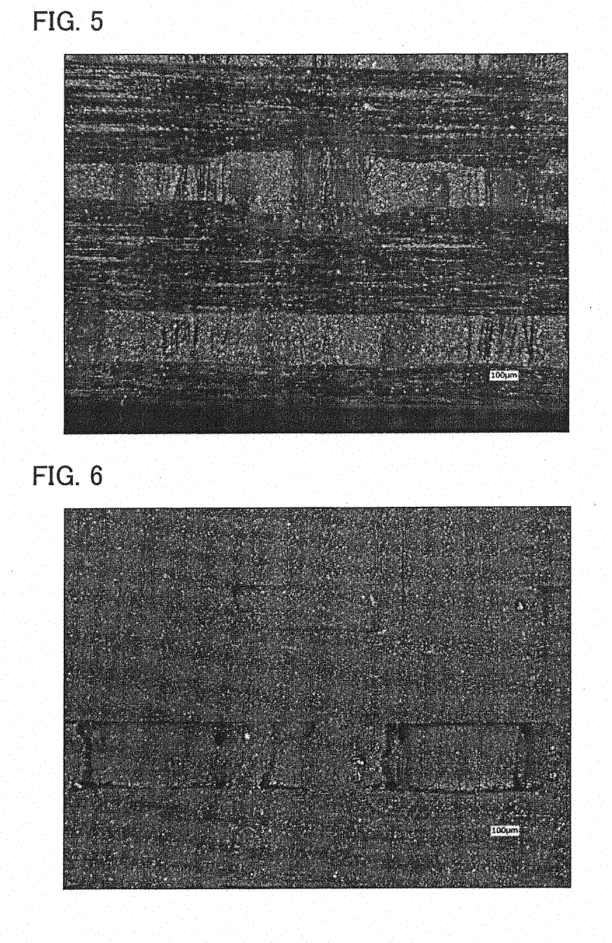

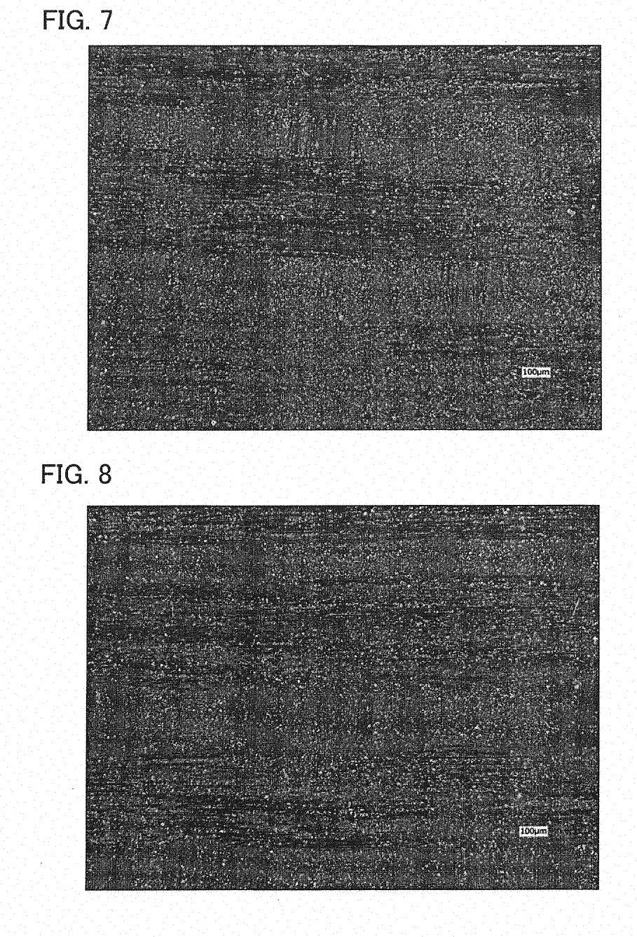

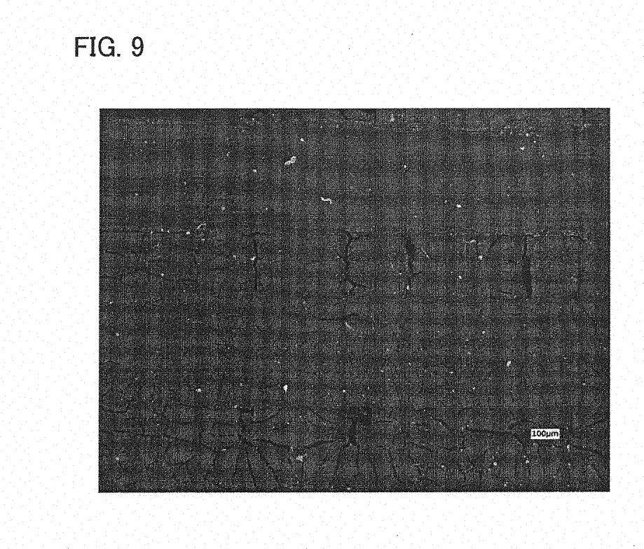

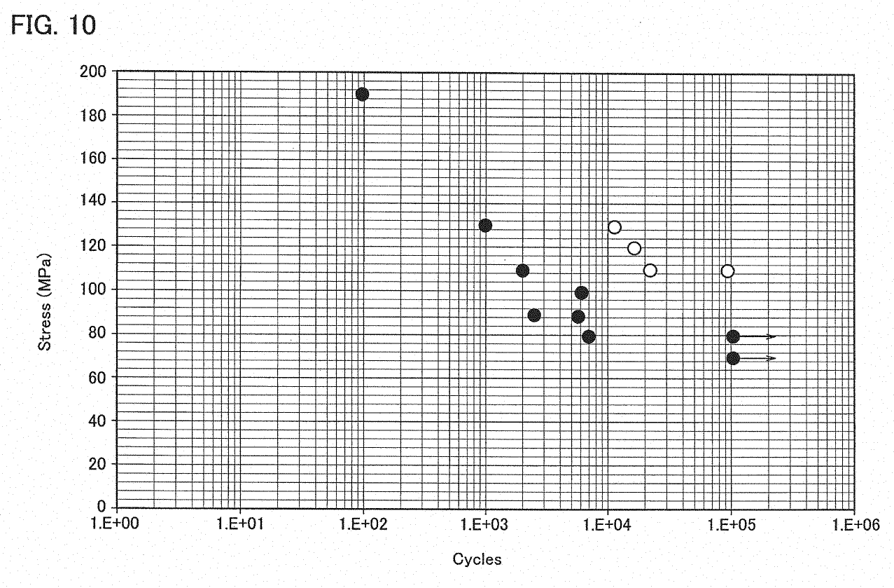

Determined influence of the ratios of glass on appearances will be described below in regard to examples in which the grain size of SiC is 9.5 micrometers and the grain size of glass is 5 micrometers. The example where the ratio of glass is 0% (see FIG. 5) exhibits that the pores among the fibers are insufficiently filled and the example of 10% (see FIG. 6) is also observed to be insufficient. The examples of from 30 through 80% (see FIGS. 7 and 8) exhibit that the pores seem sufficiently filled in appearance. The example where the ratio of glass is 100% (see FIG. 9) exhibits many cracks in the matrix. The results of determination in appearance are summarized in Table 1. On the basis of these results, the volume fraction of glass to SiC is from 10 through 80% for instance, or more preferably from 30 through 80%.

TABLE 1
Influence of the volume fraction of glass on appearance

| Volume fraction of glass | Appearance |
|---|---|
| 0 | poor |
| 10 | middle |
| 30 | good |
| 50 | good |
| 60 | good |
| 70 | good |
| 80 | good |
| 100 | poor |

Test pieces exhibiting good appearance were further subject to high temperature tension fatigue tests. The test method conformed to ASTM C1360 and the tests were executed in the air at 1150 degrees C. The test results are shown as S-N curves in FIG. 10. The grain size of SiC is 9.5 micrometers and the grain size of borosilicate glass is 5 micrometers. The test pieces were machined into a shape of a tensile test piece and as-machined test pieces were used in the tests. The test piece with 0% glass (filled circle in the drawing) is compared with the test piece with 50 vol glass (open circle). Under any stress, the cycles until fracture about those including glass are greater than those without glass. The fatigue limit of those without glass is higher than those including glass.

As described already, the glass filled in the pores prevents water vapor from contacting with the coating on the fibers particularly at high temperatures and therefore improves high temperature oxidation resistance. In addition to this effect, addition of glass is acknowledged to be effective in improvement of fatigue strength at high temperatures.

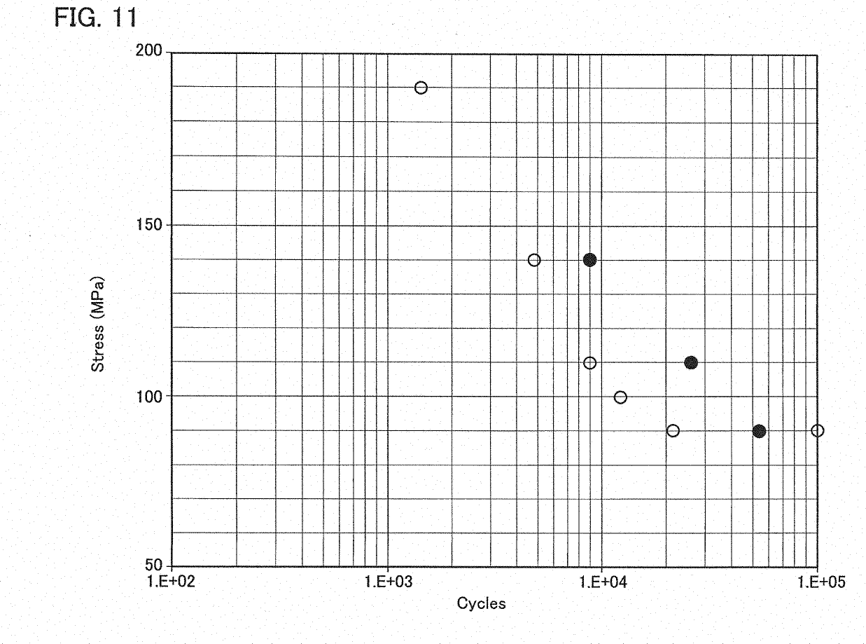

Test pieces processed with machining, filling, surface coating and spraying were also subject to high temperature tension fatigue tests. Results are summarized in FIG. 11. Filled circles in this drawing depict results of the test pieces with oxidation-resistant coatings formed by spraying a mixture of mullite and ytterbium silicate, and open circles depict those without spray coatings. Although a difference in fatigue limit is not clear, the cycles until fracture of those with the oxidation-resistant coatings are greater than those without coatings.

As the oxidation-resistant coatings shield the fibers from the environment, oxidation resistance of the ceramic matrix composite is improved. In addition to this effect, it is further acknowledged that the coating is effective in improvement of fatigue limit.

Next, oxidation resistance was determined by exposure of test pieces without coatings to high-temperature water vapor. Aside from omission of coating formation by surface coating and spraying, the way of producing test pieces is the same as those described above, and the test pieces ware rectangular in dimensions of 15 (length)×6 (width)×3 (thickness) mm. The ratios of glass to SiC were 0, 20, 30, 50, 60, 70, 80 and 100 vol %, respectively. After exposing them to the atmosphere including 90 vol % water vapor at 1100 degrees C. for 100 hours, the test pieces were taken out and observed in appearance, and the thickness changes (increases) were measured.

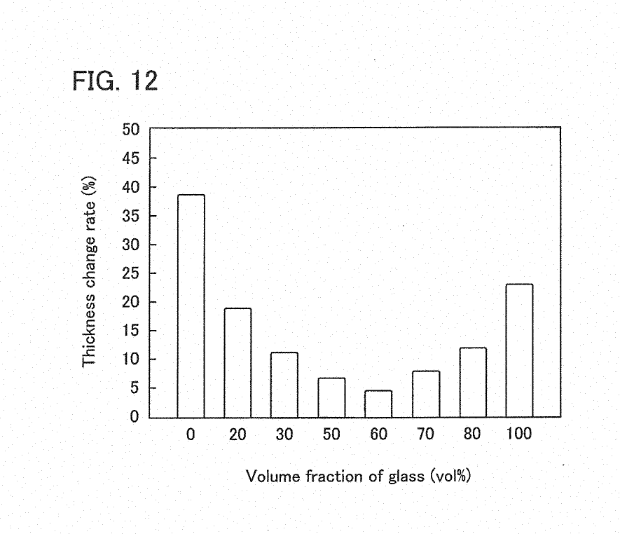

FIG. 12 is a graph showing thickness changes as ratios to initial thicknesses (thickness change rates). As the thickness change rate is smaller, the oxidation resistance is determined to be better. As being apparent from these measurement results, greater ratios of glass to SiC lead to better oxidation resistances in the range of from 0 vol % to 60 vol %. On the other hand, in the range of from 100 vol % to vol %, however, smaller ratios of glass to SiC lead to better oxidation resistance.

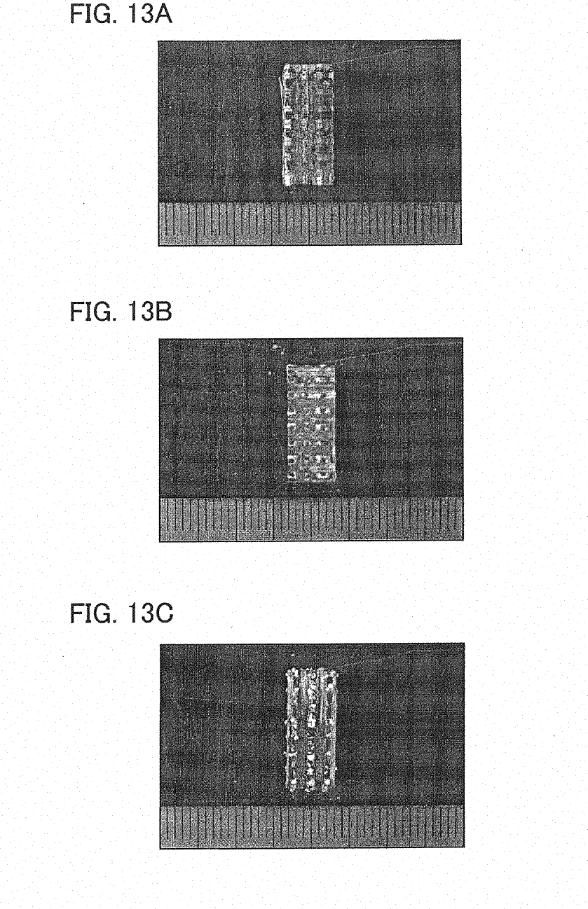

The observation on the test piece with 0 vol % glass relative to SiC after the exposure test (see FIG. 13A) reveals that the matrix diminishes more and the SiC fibers are damaged more as compared with that of the test piece with 60 vol % glass (see FIG. 13B) do. Consequently, it is inferred that a larger content of glass in the filler makes pore closure be more complete and provides better prevention of intrusion of high-temperature air and water vapor, thereby improving oxidation resistance.

Further, the observation on the test piece with 100 vol % glass relative to SiC after the exposure test (see FIG. 13C) reveals that irregular deformations occur on its surface as compared with the test piece with 60 vol % glass (see FIG. 13B). A more detailed observation on these bumps reveals that they seem to be mainly of glass. More specifically, it is inferred that the bumps are traces after the glass in the interior blows out at high temperatures. Glass would have fluidity at high temperatures and is therefore useful in filling pores in CMC, but excessive glass would close paths through which expanding air can escape to the exterior. It could be therefore inferred that the expanding air presses the glass to blow out. Taking these results and the oxidation resistance into consideration, it is inferred that excessive glass damages the quality of sealing ability and the oxidation resistance might be therefore reduced.

More specifically, to improve oxidation resistance, attention should be directed to both the degree of pore closure and glass blowing. In light of improvement of the degree of pore closure, the ratio of glass to SiC is 10 vol % or more for instance, or more preferably 30 vol % or more, or still more preferably 50 vol %. On the other hand, in light of prevention of glass blowing, the ratio of glass to SiC is 80 vol % or less, or more preferably 70 vol % or less.

These test pieces with a variety of glass ratios were subject to the high-temperature tension fatigue tests on the basis of ASTM C1360. The tests were executed in the air at 1160 degrees C. under the atmospheric pressure, the maximum stress was 130 MPa, the stress ratio was R0.1, and the frequency was 1 Hz.

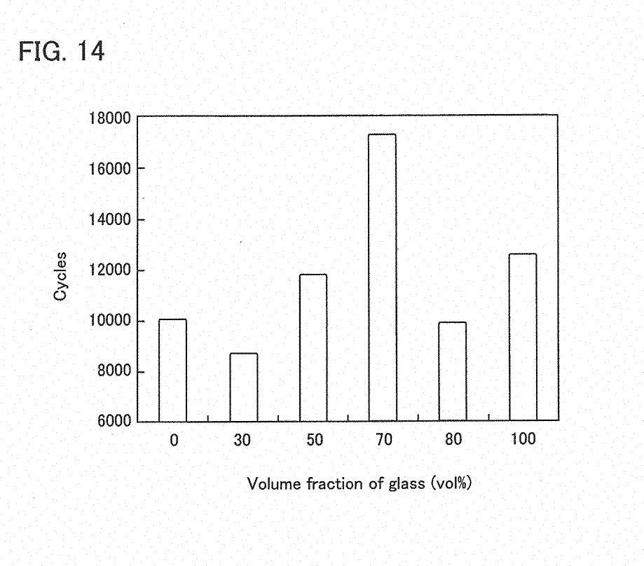

FIG. 14 represents cycles necessary to cause fracture. Although influence of the ratios of glass to SiC is not simple, it is at least acknowledge that the range of from 50 through 70 vol % creates good fatigue resistance.

Although certain embodiments have been described above, modifications and variations of the embodiments described above will occur to those skilled in the art, in light of the above teachings.

What is claimed is:

1. A method for producing a ceramic matrix composite, comprising:
weaving a fabric from fibers of SiC;
infiltrating SiC into pores in the fabric by vapor phase infiltration;
executing solid phase infiltration by immersing the fabric after the vapor phase infiltration in an immersion liquid including a solvent, a SiC powder and a glass powder to infiltrate SiC and glass into the fabric; and
executing liquid phase infiltration by immersing the fabric after the solid phase infiltration in an immersion liquid including a solvent and an organic silicon polymer and calcine the immersed fabric to infiltrate SiC into the fabric.

2. The method of claim 1, wherein the glass powder includes borosilicate glass.

3. The method of claim 1, wherein the step of infiltrating includes executing vapor phase infiltration to heat the fabric in an atmosphere including hydrogen and a SiC ingredient gas.

4. The method of claim 1, further comprising:
executing filling by immersing the fabric after the liquid phase infiltration in a slurry including a SiC powder; and
heating the fabric after the step of filling in an atmosphere including hydrogen and a SiC ingredient gas to coat a surface of the fabric after the step of filling.

5. The method of claim 4, further comprising:
spraying Si, mullite and ytterbium silicate onto the coated fabric.
